(19) United States
(12) Patent Application Publication
(10) Pub. No.: US 2025/0315779 A1
(43) Pub. Date: Oct. 9, 2025

(54) AUTOMATED GANTRY SYSTEM FOR PRECISE ITEM HANDLING, STORAGE, AND DELIVERY

(71) Applicant: VenHub IP, LLC, Pasadena, CA (US)

(72) Inventors: Shoushana Ohanessian, Pasadena, CA (US); Andres Munoz, West Covina, CA (US); David Leandro, Norwalk, CA (US); Stepan Cholakhyan, Glendale, CA (US); Shahan Ohanessian, Glendale, CA (US)

(21) Appl. No.: 18/970,312

(22) Filed: Dec. 5, 2024

Related U.S. Application Data
(60) Provisional application No. 63/606,111, filed on Dec. 5, 2023.

(51) Int. Cl. G06Q 10/0836; B65B 43/46; B65B 43/54; B65G 1/04; B65G 1/137; G06Q 30/0601

(52) U.S. Cl. CPC G06Q 10/0836; B65B 43/465; B65B 43/54; B65G 1/0435; B65G 1/1371; B65G 1/1375; G06Q 30/0641; B65G 2209/02

(57) ABSTRACT

An automated product handling system and method for efficiently storing, retrieving and delivering bagged items includes a frame assembly housing a multi-tiered gantry system with vertical storage shelves, and a delivery box mounted for vertical movement adjacent to the storage shelves. A telescoping delivery drive system moves the delivery box vertically to align with selected storage shelves. The delivery box includes a horizontally extensible conveyor system and automated bag handling mechanisms comprising vacuum cups to secure bag bottoms and vertically moveable hooks to lift bag sides around products. A control unit coordinates system operations including receiving customer orders through a mobile application, optimizing storage shelf selection based on delivery timing and customer proximity, controlling product bagging and storage, and managing customer retrieval operations. The system enables fully autonomous operation with dynamic storage assignment, multi-shelf order coordination, and automated fault handling. Methods for operating the system include receiving orders, selecting optimal storage locations, automated bagging and shelf transfer operations, and controlled customer retrieval processes.

### CROSS-REFERENCE TO RELATED APPLICATIONS

This application claims the benefit of U.S. Provisional Application No. 63/606,111 titled “Automated Gantry System for Precise Item Handling, Storage, and Delivery,” filed by the inventors herein on Dec. 5, 2023, the specification of which is incorporated herein by reference in its entirety.

### FIELD OF THE INVENTION

The present invention relates to enhanced gantry systems for efficiently storing, handling, retrieving and delivering goods in a commercial setup. More particularly, the present disclosure describes methods and systems for an automated gantry system specifically engineered to enhance precision in handling, storing, and delivering items. The invention encompasses both apparatus and methods, including a physical gantry system with mechanical components for precise item handling and computerized methods for controlling the automated system. The disclosure particularly relates to systems and methods for implementing an advanced item packaging, storage, and retrieval approach where a product conveyor moves along a Y-axis until reaching the required item location, utilizing X-axis movement to position and retrieve items accurately into and from designated storage locations a grid, and employing sophisticated pneumatic systems for streamlined bagging processes.

### BACKGROUND OF THE INVENTION

Gantry systems are employed in various industries to provide a range of benefits in manufacturing, material handling, and automation processes. A gantry system is a mechanical structure consisting of various components working together to enable precise and controlled multi-axis linear motion. In industrial applications, gantry systems may function as industrial robots with a mechanical framework that uses a movable trolley over a linear bridge. These systems can be equipped with various end effectors and control mechanisms to handle different types of items and materials. The systems typically operate using sophisticated software algorithms and control systems that coordinate movements and operations across multiple axes.

However, existing gantry systems face limitations in precision handling, especially for automated storage and delivery applications. For instance, existing systems struggle with maintaining consistent accuracy and often require manual intervention for complex operations.

Moreover, existing systems lack the ability to optimize delivery times and customer experience, such as that which may be achieved by dynamically assigning storage locations and delivery bins based on customer proximity and order schedules. Furthermore, existing systems do not provide an automatic bagging system that simplifies the retrieval process and reduces congestion. Therefore, there is a need for an improved automated gantry system that overcomes these limitations and provides enhanced efficiency, accuracy, and customer satisfaction.

### SUMMARY OF THE INVENTION

In accordance with certain aspects of a preferred embodiment, an advanced automated gantry system is provided having an automatic product bagging, storage, and retrieval system, and a process of optimized delivery for fast customer product order processing time. The process may be carried out via a mobile device application enabling customers to place orders via their mobile device and have items bagged and stored within the gantry for automated retrieval at a later time. The gantry system operates through a combination of mechanical hardware backed by appropriate software to control the entire mechanism.

During operation, a prefolded/collapsed plastic bag is placed on top of the lift conveyor belt from a storage supply. Once placed, four suction cups secure the base of the plastic bag to the conveyor. At this point, one or more items purchased remotely by a customer are externally inserted into the gantry through a side import door and placed on top of the secured plastic bag. Once placed, lifting arms within a delivery box raise and hook onto the sides of the plastic bag so as to only lift up the walls of the bag, thus bagging the item while the base remains suctioned and secure. Once this operation is complete, the suction is released and the lift is able to autonomously raise or lower depending on which conveyor shelf of the gantry is available to have the bag stored. Once a conveyor shelf within the gantry is determined to be free, the lift will raise or lower to that level and extend the lift conveyor horizontally to be flush against the conveyor of the gantry shelf through the use of a linear actuator mounted beneath the lift. Once the two conveyors are flush and level, both conveyors will activate and drive the bagged item onto the gantry conveyor shelf. Once complete the lift conveyor will retract. The lift will then return back to its home position ready to repeat the process for subsequent remote customer orders.

When a customer is ready to retrieve their order, the lift will simply re-preform the foregoing process in reverse. The empty lift will raise or lower to the correct level of the gantry at which the desired item to be retrieved is stored. The lift conveyor extends until it is flush and level with the gantry conveyor shelf. Then both conveyors will activate and drive the bagged item in the opposite direction into the delivery box. Finally, the lift conveyor will retrace and the lift will lower to the home position for the items to be retrieved from a front window by the customer. The mechanical system is configured with NEMA23 stepper motors and linear actuators to carry out such automated movements.

An application on the customer's mobile device is configured to optimize delivery by calculating processing times, queuing orders, and coordinating picking and storage based on customer proximity to minimize delivery times. The system maintains bilateral communication throughout its components to ensure constant contact for repeatability and accuracy, with continuous monitoring that enables real-time recalibration if alignment issues are detected. This integration creates a fully autonomous system that processes delivery of products when customers are en route, utilizing control software to coordinate the picking, placing and storage of products.

The invention's unique integration of these features creates a fully autonomous system that significantly improves efficiency. The system can operate independently across multiple locations, with each store managing its own queue process without interference. The system is designed to be scalable and adaptable, with the ability to accommodate larger or smaller products without significant hardware or software modifications. Additionally, the grid system can be dynamically reconfigured if part of the system becomes inoperable, automatically reassigning orders to other units to maintain continuous operation. The system may include 3D sensors for redundant monitoring.

Still other aspects, features and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized. The present invention is illustrated by way of example, and not by way of limitation, in the figures of the accompanying drawings, in which like reference numerals refer to similar elements, and in which:

FIG. 1 is a perspective view of an automated product bagging, storage, and retrieval system in accordance with certain aspects of an embodiment of the invention.

FIG. 2 is a perspective view of the interior of the system of FIG. 1.

FIG. 3 is a perspective view of the telescoping delivery drive system and delivery box of the system of FIG. 1.

FIG. 4 is a close-up bottom perspective view of the delivery box of FIG. 3 mounted to the telescoping delivery drive system.

FIG. 5 is a close-up bottom perspective view of the delivery box of FIGS. 3 and 4.

FIG. 6 is an exploded view of the delivery box of FIGS. 3-5.

FIG. 7 is a bottom, front perspective view of a drive system of the delivery box of FIGS. 3-6.

FIG. 8 is a bottom, back perspective view of a drive system of the delivery box of FIGS. 3-6.

FIG. 9 is a perspective view of a bag hook for use in the delivery box of FIGS. 3-6.

FIG. 10 is a perspective view of the system of FIG. 2 showing the delivery box in a first position to receive and bag selected products and to deliver retrieved, bagged products to a customer.

FIG. 11 is a perspective view of the system of FIG. 10 showing the delivery box in a second position aligned with a selected open shelf.

FIG. 12 is a perspective view of the delivery box of FIGS. 3-6 with the bag hooks in a lower, retracted position.

FIG. 13 is a perspective view of the delivery box of FIGS. 3-6 with the bag hooks in a raised position suitable for lifting the sides of a bag around product(s) positioned inside of the delivery box.

FIG. 14 is a perspective view of the delivery box of FIGS. 3-6 showing the delivery box conveyor deployed to contact an adjacent storage shelf.

FIG. 15 is a flowchart of an exemplary embodiment of the method for automated item handling according to the invention.

FIG. 16 is a flowchart of an exemplary embodiment of the method for managing multiple storage units according to certain aspects of an embodiment of the invention.

### DETAILED DESCRIPTION OF THE PREFERRED EMBODIMENTS

The invention may be understood by referring to the following description and accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Descriptions of well-known functions and structures are omitted to enhance clarity and conciseness. The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item.

The use of the terms “first”, “second”, and the like does not imply any particular order, but they are included to identify individual elements. Moreover, the use of the terms first, second, etc. does not denote any order of importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although some features may be described with respect to individual exemplary embodiments, aspects need not be limited thereto such that features from one or more exemplary embodiments may be combinable with other features from one or more exemplary embodiments.

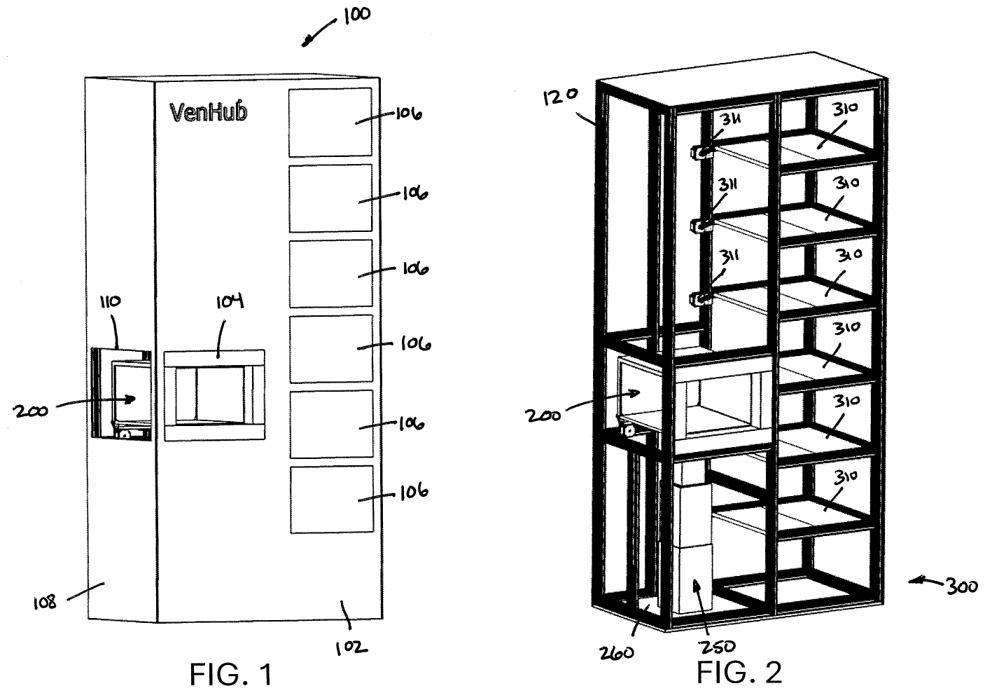

With particular reference to FIGS. 1 and 2, an exemplary embodiment of an automated product bagging, storage, and retrieval system 100 is shown according to certain aspects of an embodiment. The system 100 includes exterior walls that allow controlled access to bagged products that are to be dispensed to customers, and that provide views of products stored inside of system 100 on various vertical shelves of the system 100. More particularly, a front, customer-facing wall 102 may provide an opening 104 enabling a customer to retrieve an order from a vertically moveable delivery box 200 after the customer has been verified by an automated controller (not shown) of system 100 and the order has been retrieved from its respective storage shelf 310 inside of a gantry 300. Front wall 102 may include windows 106 the provide visibility into each shelf 310 of gantry 300 while blocking physical access to shelves 310. Likewise, a side wall 108 provides an opening 110 allowing access to the delivery box 200 through an open side of delivery box 200, such that product stored in inventory may be placed into the system 100 for bagging and storage on an open shelf 310, as discussed in greater detail below.

In this configuration, system 100 is adapted to receive product from its storage location, and in a particularly preferred embodiment in an automated product storage facility that provides automated, robotic product selection from storage and placement inside of delivery box 200 upon order of such product from a customer, bag and store the selected product (or products) on an open shelf, and ultimately retrieve and deliver such products from the shelf 310 to the customer through opening 104 when the customer arrives. System 100 may be located, in exemplary embodiments, in a convenience store, a grocery store, a warehouse, or such other facility that may automatically fulfill customer orders. System 100 may be integrated with a user application, discussed below, that allows customers to place orders and retries items from system 100.

As best viewed in FIG. 2, system 100 comprises an internal frame assembly 120 constructed, by way of non-limiting example, of aluminum extrusions, such as 45 mm extrusions, that provide a sturdy and durable structure for supporting the other components of system 100. Frame 120 defines a rectangular space within which the gantry 300 and vertically moveable delivery box 200 are arranged. Frame 120 also includes rails, bearings, and slides (the configurations of which are well known to those of ordinary skill in the art) that enable delivery box 200 to move along a Y-axis within frame 120 to align with a designated shelf 310. Frame 120 can have various dimensions depending on the desired storage capacity and space availability. For example, frame 120 can have dimensions in a particular embodiment of 24″×24″×86″.

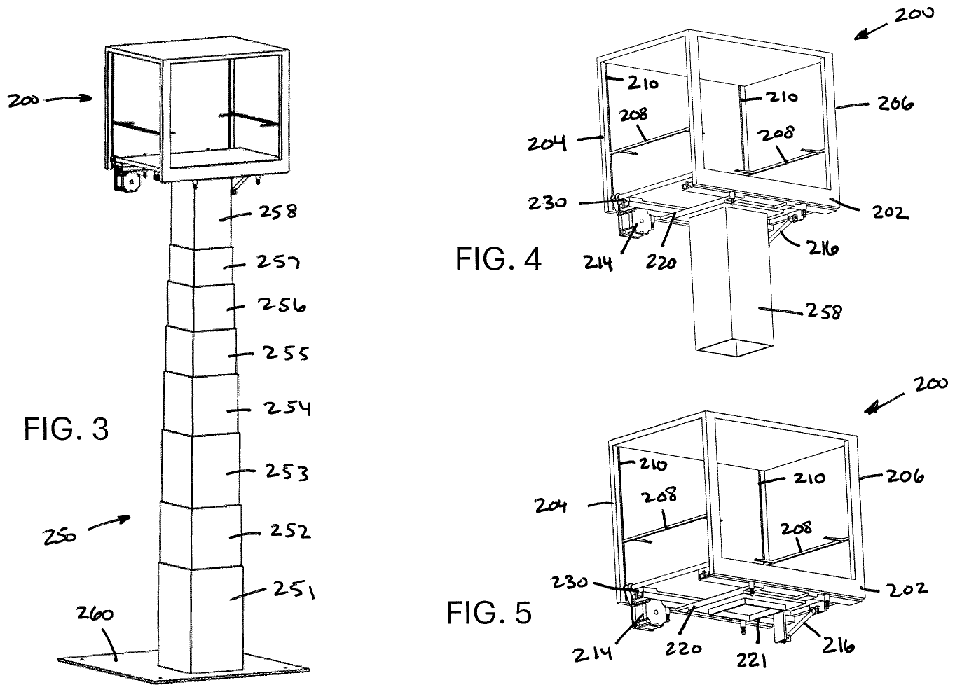

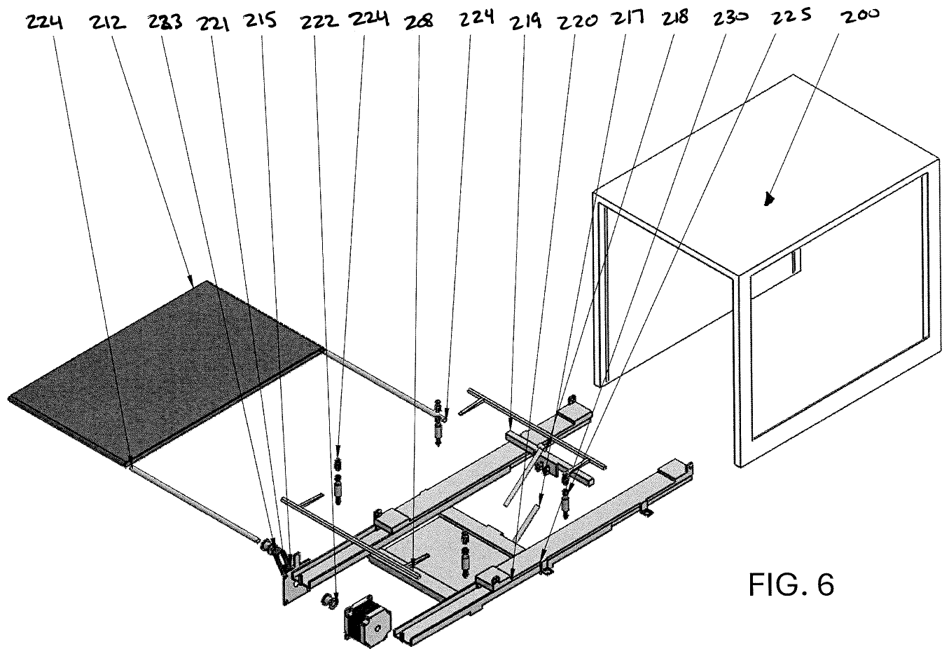

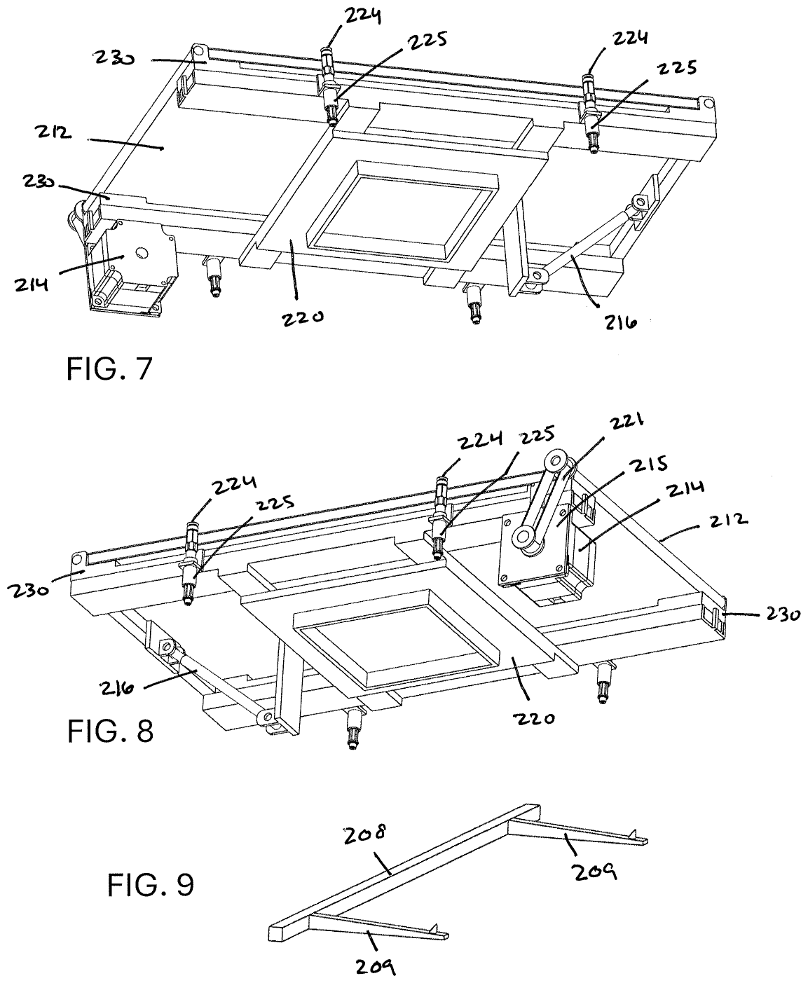

A telescoping delivery drive system 250, which in certain exemplary embodiments may be pneumatically driven, facilitates the delivery of items received through opening 110 of side wall 108 into delivery box 200 to a designated open shelf 310, and to customers after retrieval by delivery box 200 from that shelf 310 through opening 104 in front wall 102, all in a convenient and efficient manner. Thus and by way of non-limiting example, telescoping delivery drive system may comprise a plurality of stacked, nested lifting arms 251-258, the bottom-most of which 251 is fixed to a base 260 of gantry 300. While FIG. 3 shows a total of 8 telescoping lifting arms 251-258, any number of lifting arms may be provided depending on the sizing needs for a given installation of system 100. However, in each case a bottom most lifting arm 251 and an upper most lifting arm 258 will be provided, with upper most lifting arm 258 being affixed to the bottom of delivery box 200, as further detailed below with reference to FIGS. 4-8.

Delivery box 200 is configured to hold and expand bags that may be placed inside of delivery box 200 for use in packaging items for delivery to a customer, and may thus be variably vertically positioned in gantry 300 to place bagged items onto one of shelves 310 or retrieve bagged items from one of shelves 310 for delivery to opening 104 for customer retrieval. In certain exemplary configurations, bags may be positioned in delivery box 200 by a bag positioning and replacement mechanism that can be a conveyor belt, a roller, a robotic arm, or other suitable device that can move and align the bags into the delivery box 200. System 100 may also include 3D sensors (not shown) that may be positioned to provide feedback on the location and orientation of items and the bags.

With particular reference to FIGS. 4-8, delivery box 200 has a front face 202 forming a rectangular frame with an open interior to allow customer access to the interior of delivery box 200. Delivery box 200 likewise has a first side face 204 forming a rectangular frame with an open interior to allow product inventory to placed inside of delivery box 200 for bagging, as discussed below. Still further, delivery box 200 has a second side face 206 forming a rectangular frame with an open interior through which bagged products ordered by a customer may pass onto and from shelves 310. The floor of delivery box 200 is formed by conveyor 212 that may be operated by a stepper motor 214 (mounted to stepper motor mount 215) to move bagged product from delivery box 200 onto an adjacent shelf 310, and/or to move bagged product form such adjacent shelf 310 back into delivery box 200.

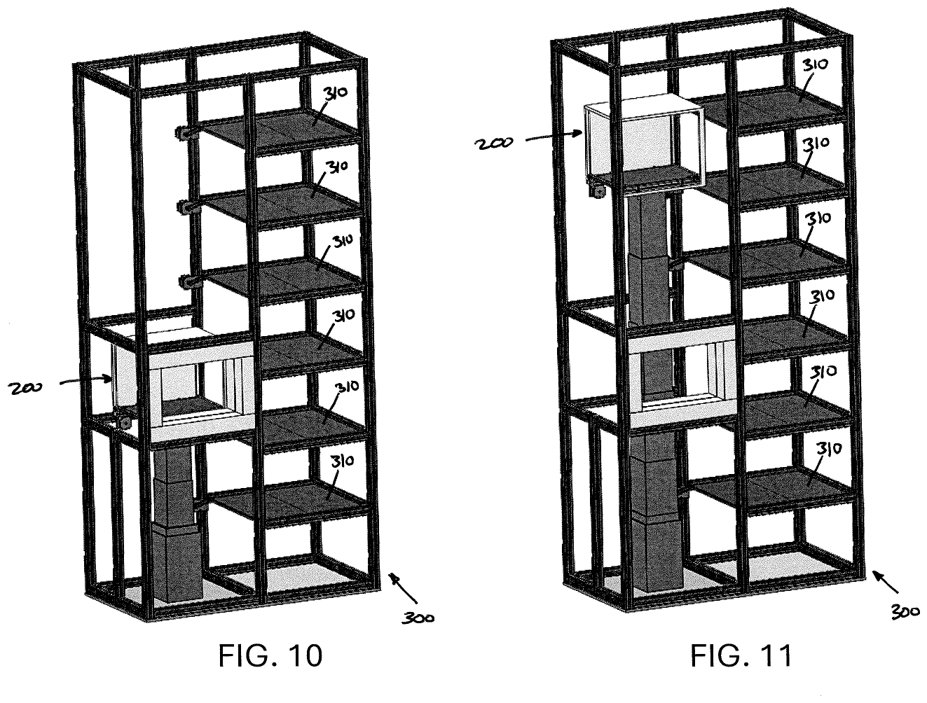

To ensure a smooth transition of bagged product between delivery box 200 and shelves 310, conveyor 212 of delivery box 200 is mounted for lateral movement toward and away from shelves 310. In this regard, a lateral slider assembly comprises a bottom slider 220 and a top slider 230. Bottom slider 220 includes a bottom slider mount 221 that is affixed to upper most lifting arm 258 of the telescoping delivery drive system. A top side of bottom slider 220 mounts top slider 230 for sliding horizontal movement. Top slider 230 carries conveyor 212 of delivery box 200 (along with stepper motor 214 such that the conveyor 212 may be moved toward and away from shelves 310 while the telescoping delivery drive system, bottom slider mount 221 and delivery box 200 remain stationary). This enables delivery box 200 to, as shown in FIGS. 10 and 11, be vertically positioned adjacent to a designated open shelf 310 and, after such vertical alignment, for conveyor 212 to be horizontally moved, as shown in FIG. 14, to contact (or near contact) with the adjacent shelf 310 for smooth transition of bagged product between the delivery box 200 and the storage shelf 310. To affect such lateral movement, a linear actuator 216 (having a cylinder 217 and extensible piston 218 connected to an underside of top slider 230 at a linear actuator mount 219) extends between bottom slider 220 and top slider 230 to, when engaged, cause delivery box 200 to move toward (or away from) an adjacent shelf 310. Once delivery box 200 has been positioned immediately adjacent to a designated shelf 310, stepper motor 214 may (via conveyor drive belt 221, pulleys 222 and 223, and conveyor drive roller 224) rotate conveyor 212 to move bagged product between delivery box 200 and the adjacent storage shelf 310.

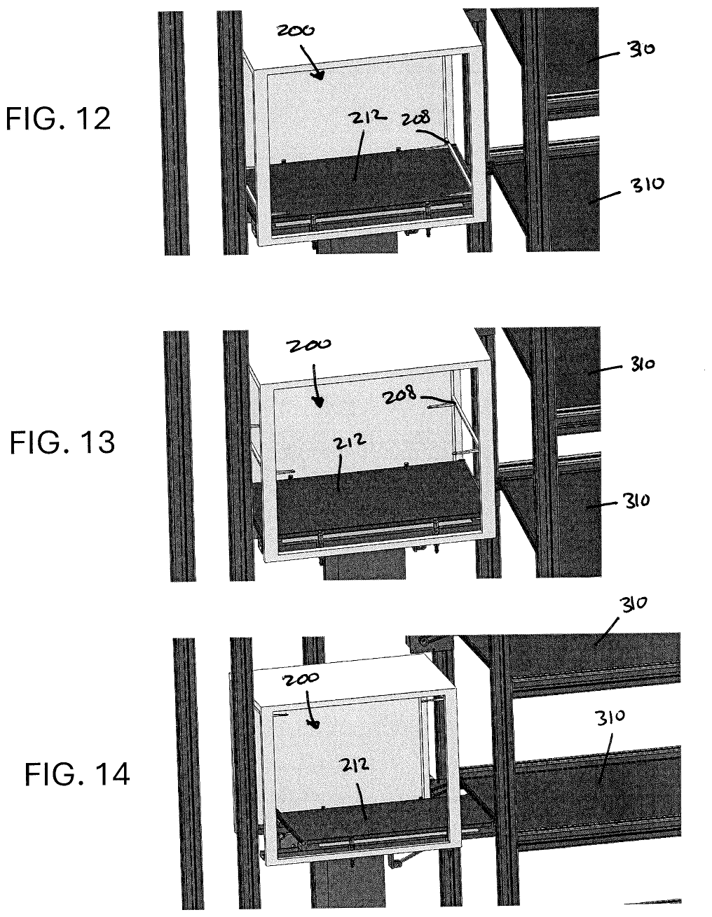

Additionally, bag hooks 208 (shown in detail in FIG. 9) are vertically mounted in slide rails 210 on interior facing sides of delivery box 200 and, as particularly shown in FIGS. 12 and 13, may be moved upward and downward adjacent to the outer sides of delivery box 200 through any electronically controlled linear actuator as may be readily selected by those skilled in the art. Each bag hook 208 includes hook arms 209 that face the interior of delivery box 200, which hook arms 209 are positioned to engage and grab the open handles or sidewalls of a standard plastic grocery or convenience store bag. Further, vacuum cups 224 (which are connected to any suitable vacuum source and mounted to and carried by vacuum cup levelers 225, which in turn are mounted to top slider 230) are located at peripheral edges of the bottom of delivery box 200 for applying suction to a flexible plastic bag to hold the bag in position as bag hooks 208 lift the sides of the bag around product that has been placed in delivery box 200. Thus, with a prefolded/collapsed plastic bag being placed on top of the conveyor 212, vacuum cups 224 secure the base of the plastic bag to conveyor 212. Any item that has been order by a customer may then be inserted into delivery box 200 through first side face 204 and placed on top of the secured plastic bag. Once placed, bag hooks 208 in delivery box 200 rise and hook onto the sides of the plastic bag so as to only lift the walls of the bag, thus bagging the customer's selected item while the base remains suctioned and secure. After this operation, suction is released and delivery box 200 is vertically moved to a position adjacent to a designated open shelf 312.

Shelves 310 of gantry 300 define a multi-tiered storage system comprised of multiple storage units arranged along the Y-axis. Each storage unit may have a designated name, such as SU1, SU2, SU3, etc., that corresponds to a specific location within the frame 120 of gantry 300. Each storage unit can store bags containing multiple items of various types and sizes, depending on the customer orders and inventory levels. The multi-tiered vertical storage system can have different numbers of storage tiers, depending on the desired storage capacity and space availability. For example, the vertical storage system can have six storage tiers. With this configuration, after delivery box 200 is vertically moved to a position adjacent to a designated open shelf 312, conveyor 212 of delivery box 200 may be moved horizontally by linear actuator 216 to be positioned flush against a conveyor on the respective adjacent open shelf 312 driven by a shelf conveyor motor 311, which shelf conveyor has a generally like configuration to that of conveyor 212. Once the conveyor 212 of delivery box 200 is flush and level with the conveyor of the adjacent open shelf 312, both conveyors are engaged to drive the bagged item(s) fully onto the conveyor of the gantry shelf 312, after which the delivery box conveyor 212 is retracted back into delivery box 200. Delivery box 200 may then be lowered to align with opening 110 to receive additional products for bagging and storage, thus repeating the above processes. When a customer arrives to retrieve their order, delivery box 200 simply re-performs the above processes in reverse, such that the empty delivery box 200 is raised or lowered to the correct level at which the desired item that is to be retrieved is currently stored. The conveyor of delivery box 200 is horizontally extended until flush and level with the conveyor of the associated shelf 310, and both conveyors are engaged to drive the bagged item in the opposite direction into the delivery box 200. Finally, the conveyor 212 of delivery box 200 is retracted into delivery box 200 and delivery box 200 is lowered to align with opening 104 to enable the customer to retrieve their order.

A control unit (not shown) coordinates the foregoing movements and operation of system 100, and may be housed in a unit positioned within gantry 300 or remote but in data communication with gantry 300. The control system may include, among other elements, a processor, a memory, and a communication module. The processor executes software instructions stored in the memory that implement various algorithms and functions of the control system. The communication module enables the control system to communicate with a user application on, for example, a remote mobile device, and the gantry 300 (including the telescoping drive system 250 and the individual shelves 310). The control system maintains bilateral communication with all the components of the system 100 to ensure constant contact for repeatability and accuracy. The control system also continuously monitors the system performance and performs real-time recalibration if alignment issues are detected. The control system may also create service tickets automatically for faulty components and updates inventory management in real-time.

The user application is a software application that allows customers to interact with the system 100. The user application can be installed on a mobile device, such as a smartphone, a tablet, or a laptop, or accessed through a web browser or a kiosk. The user application enables customers to create accounts, browse items, place orders, schedule deliveries, confirm arrivals, scan bins, and provide feedback. The user application preferably communicates with the control system to transmit and receive information about the orders, the items, the storage units, the delivery bins, and the system status.

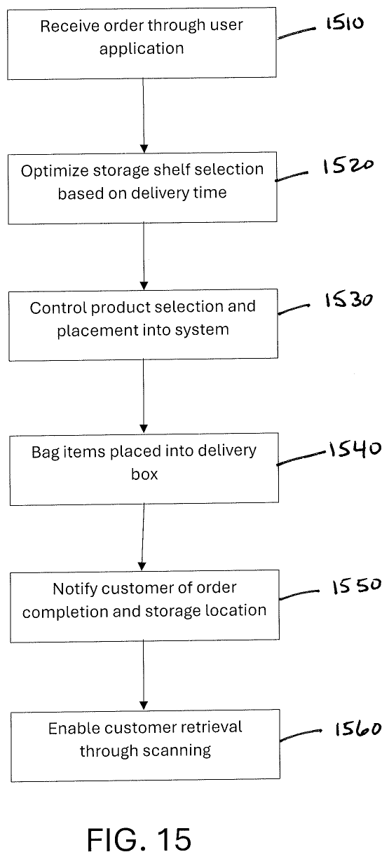

FIG. 15 shows a flowchart of an exemplary embodiment of the method for automated item handling according to the invention. The method comprises the following steps:

Step 1510: Receiving an order through a user application. The user application allows customers to place orders for items that are stored in the system 100. The user application transmits the order information, such as the item names, quantities, and delivery preferences, to the control system.

Step 1520: Optimizing storage shelf selection based on delivery time. The control system assigns an optimal storage shelf for each order based on the delivery time and the customer proximity. The control system preferably evaluates the order queue status, the availability of the open storage shelves on systems 100, and the location of the customer to determine the fastest and most convenient system 100 and storage shelf 310 for each order. The control system may also calculate the processing time for each order based on the item types, sizes, and locations.

Step 1530: Controlling product selection and placement into system 100. The control system controls the movement and operation of any automated systems at the location of system 100 that are configured for transferring product from storage or stock shelves to system 100. For example, a warehouse, convenience store, or other facility may be equipped with robotic arms that execute pick and place operations for each order. The control system may coordinate the movements of robotic arms to access the required items from the storage system and place them through opening 110 onto a bag in delivery box 200. The control system may also use feedback from 3D sensors to ensure precise and accurate positioning and orientation of the items and the bags.

Step 1540: Bagging items placed into the delivery box. The delivery box 200 pneumatic system grabs and holds the bottom of a flexible bag, and bag hooks 208 are lifted in delivery box 200 to grab the sides of the plastic bag and raise the sides to bag the ordered items, after which the vacuum pressure is released and the bagged item is moved to the selected shelf 310.

Step 1550: Notifying a customer of order completion and storage location. The control system notifies the customer through the mobile application of the completion of their order and preferably the assigned delivery shelf for their order through the user application. The control system also preferably provides a barcode or a QR code that the customer can scan to access the particular delivery shelf to retrieve their order.

Step 1560: Enabling customer retrieval through scanning. Upon arrival at system 100, the customer preferably scans the barcode or the QR code provided by the control system using their mobile device or a kiosk. The control system verifies the scan and controls gantry 300 to retrieve the customer's ordered product and deliver it to opening 104 for customer retrieval. The customer retrieves their order and the control system updates the order status and the inventory level accordingly.

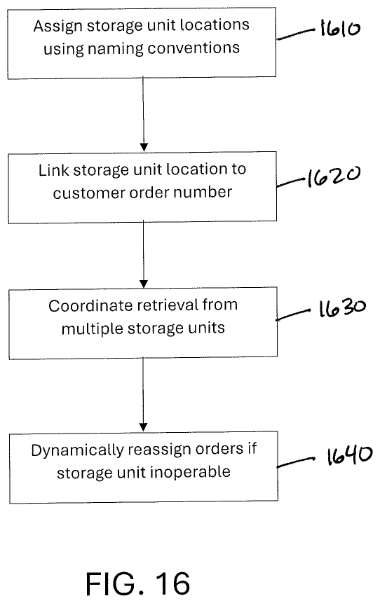

Next, FIG. 16 shows a flowchart of an exemplary embodiment of the method for managing multiple storage units according to certain aspects of an embodiment of the invention. The method comprises the following steps:

Step 1610: Assigning storage unit locations using naming conventions. The control system assigns storage unit locations for each order using naming conventions, such as SU1, SU2, SU3, etc. The control system optimizes the storage unit locations based on the item types, sizes, and locations.

Step 1620: Linking storage unit locations to customer order numbers. The control system links the storage unit locations to the customer order numbers and stores the information in the memory. The control system also transmits the information to the user application for customer notification.

Step 1630: Coordinating retrieval from multiple storage units for large orders. The control system coordinates the retrieval of items from multiple storage locations for large orders that require more than one shelf 310. The control system controls the movement and operation of gantry 300 to access the required items from the multiple shelves 310 and place them into the the delivery platform box 200.

Step 1640: Dynamically reassigning orders if a storage unit becomes inoperable. The control system dynamically reassigns orders to other storage locations if a selected storage location becomes inoperable due to a fault or a maintenance issue. The control system detects the fault or the issue using the feedback from the sensors and the motors of gantry 300 and preferably automatically creates a service ticket. The control system also updates the storage unit locations and the customer order numbers accordingly and notifies the customers of any changes.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. Thus, it should be understood, therefore, that the invention may be practiced otherwise than as specifically set forth herein.

What is claimed is:

1. An automated product handling system comprising:
a frame assembly defining an interior space;
a multi-tiered gantry system mounted within said frame assembly comprising a plurality of storage shelves arranged along a vertical axis;
a delivery box mounted for vertical movement along said vertical axis adjacent to said storage shelves;
a telescoping delivery drive system connected to said delivery box for moving said delivery box vertically to align with a selected storage shelf;
a conveyor system mounted within said delivery box for horizontal movement toward and away from said storage shelves; and
a bag handling mechanism within said delivery box comprising:
vacuum cups positioned to secure a bottom portion of a flexible bag to said conveyor system, and
vertically moveable bag hooks configured to engage and lift side portions of said flexible bag.

2. The system of claim 1, wherein said telescoping delivery drive system comprises:
a plurality of nested lifting arms including a bottom-most lifting arm fixed to a base of said gantry system and an upper-most lifting arm connected to said delivery box.

3. The system of claim 1, wherein said conveyor system comprises:
a bottom slider mount affixed to said telescoping delivery drive system;
a bottom slider mounted to said bottom slider mount;
a top slider mounted for horizontal sliding movement relative to said bottom slider;
a conveyor belt mounted to said top slider; and
a linear actuator connected between said bottom slider and said top slider for moving said conveyor belt horizontally.

4. The system of claim 1, wherein said delivery box comprises:
a front face forming a rectangular frame with an open interior for customer access;
a first side face forming a rectangular frame with an open interior for product loading; and
a second side face forming a rectangular frame with an open interior facing said storage shelves.

5. The system of claim 1, further comprising:
a control unit in communication with said telescoping delivery drive system and said bag handling mechanism for coordinating automated movement and operation thereof.

6. The system of claim 5, wherein said control unit is configured to:
receive customer orders through a mobile application;
optimize storage shelf selection based on delivery time and customer proximity;
control product placement into said delivery box;
control bagging operations; and
enable customer retrieval of bagged products.

7. The system of claim 1, wherein each storage shelf comprises a motorized conveyor for transferring bagged products between said delivery box conveyor system and said storage shelf.

8. A method for automated product handling comprising:
receiving a customer order through a mobile application;
selecting an optimal storage shelf from a multi-tiered gantry system based on delivery time;
placing ordered items onto a flexible bag positioned within a vertically moveable delivery box;
securing a bottom portion of said flexible bag using vacuum pressure;
lifting side portions of said flexible bag around said items using vertically moveable bag hooks;
moving said delivery box vertically to align with said selected storage shelf;
transferring said bagged items onto said selected storage shelf; and
enabling customer retrieval of said bagged items through said mobile application.

9. The method of claim 8, further comprising:
extending a conveyor system of said delivery box horizontally to contact said selected storage shelf prior to transferring said bagged items.

10. The method of claim 8, further comprising:
assigning storage shelf locations using naming conventions;
linking storage shelf locations to customer order numbers; and
coordinating retrieval from multiple storage shelves for large orders.

11. The method of claim 8, further comprising:
dynamically reassigning orders to alternate storage shelves if a selected storage shelf becomes inoperable.

12. The method of claim 8, further comprising:
notifying customers through said mobile application when orders are ready for retrieval.

13. The method of claim 8, wherein enabling customer retrieval comprises:
providing a scannable code to the customer through said mobile application;
verifying said scannable code upon customer arrival; and
delivering bagged items to a customer access opening.

14. A product storage and retrieval system comprising:
a frame assembly;
a plurality of storage shelves arranged vertically within said frame assembly;
a delivery mechanism comprising:
a delivery box mounted for vertical movement adjacent to said storage shelves,
a telescoping lift system connected to said delivery box,
a horizontally extensible conveyor system mounted within said delivery box, and
an automated bag handling system within said delivery box; and
a control unit configured to:
receive customer orders,
coordinate product bagging operations,
control vertical and horizontal movements of said delivery mechanism, and
manage customer retrieval operations.

15. The system of claim 14, wherein said automated bag handling system comprises:
vacuum cups positioned to secure a bottom portion of a flexible bag; and
mechanical hooks mounted for vertical movement to lift side portions of said flexible bag.

16. The system of claim 14, wherein said horizontally extensible conveyor system comprises:
a sliding assembly mounting a conveyor belt for horizontal movement toward and away from said storage shelves; and
a linear actuator for driving said horizontal movement.

17. The system of claim 14, wherein said delivery box comprises:
a customer access opening;
a product loading opening; and
a storage shelf access opening.

18. The system of claim 14, wherein said control unit is further configured to:
optimize storage shelf selection based on customer proximity and delivery timing;
coordinate multi-shelf retrieval for large orders; and
dynamically reassign storage locations responsive to system status.

19. The system of claim 14, wherein each storage shelf comprises:
a motorized conveyor configured to transfer products between said delivery box conveyor system and said storage shelf.

20. The system of claim 14, further comprising:
a mobile application interface enabling customers to:
place orders,
receive order status notifications, and
initiate product retrieval operations.
